(19) United States
(12) Patent Application Publication
(10) Pub. No.: US 2007/0017776 A1
(43) Pub. Date: Jan. 25, 2007

(54) Coin redemption machine control system and method

(76) Inventor: James Warren, Franklin, TN (US)

Correspondence Address: LAVALLE D. PTAK;LAW OFFICE OF LAVELLE PTAK, 28435 N 42ND STREET, SUITE B, CAVE CREEK, AZ, 85331, US

(21) Appl. No.: 11/187,776

(22) Filed: Jul. 21, 2005

(51) Int. Cl. G07F 9/08; G06F 19/00; G06F 7/00; G06F 9/00

(52) U.S. Cl. 194/217

(57) ABSTRACT

A control system and method for operating a coin redemption machine includes a coin redemption machine functioning as a peripheral device to a separate computer linked to the coin redemption machine through a communications link for reciprocal communication between the coin redemption machine and the computer. The computer controls the activating and deactivating of the coin redemption machine; and the computer and coin redemption machine communicate through commands from the computer, followed by responses from the coin redemption machine.

### BACKGROUND

This invention relates to a system and method for the operation of coin redemption machines.

### BRIEF DESCRIPTION OF THE DRAWINGS

FIG. 1 is a diagrammatic flow chart of an embodiment of the invention; and

FIG. 2 is a composite block diagram/flow chart of an embodiment of the invention.

### DETAILED DESCRIPTION

Reference now should be made to the drawings in which the same reference numbers are used in both figures to designate the same or similar components or steps.

Coin redemption machines generally are designed with an ability to receive coins of mixed denominations from a consumer, to count the coins, to detect and reject foreign coins and non-coin substitutes, and finally, to produce a receipt for the consumer which may be exchanged for cash or some other form of credit from the entity controlling the coin redemption machine. Such known coin redemption machines include a computer or firmware for processing the count of coins and calculating the value of such coins, along with a printer for producing a coupon, receipt or some form of data transfer following the computation of the amount to be paid or credited to the user of the machine.

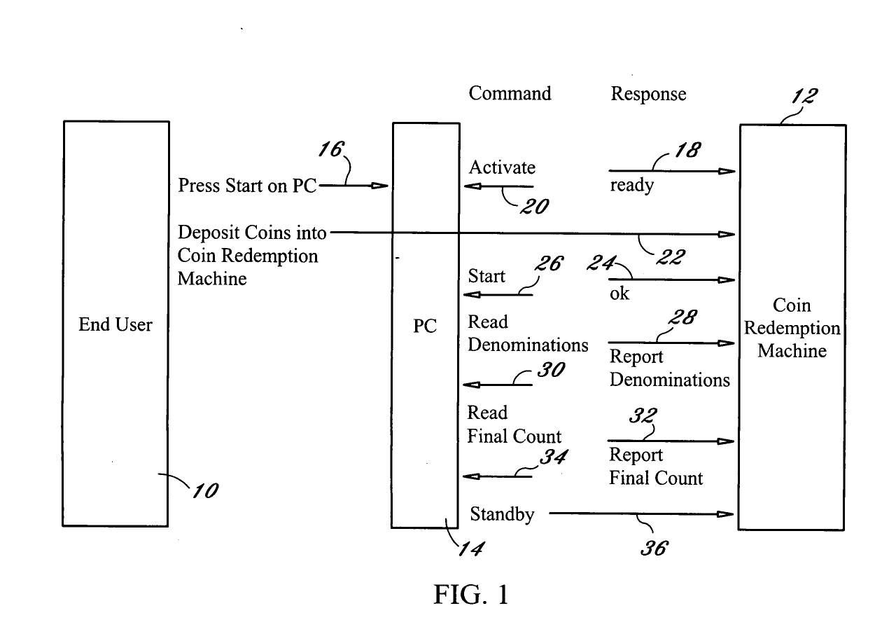

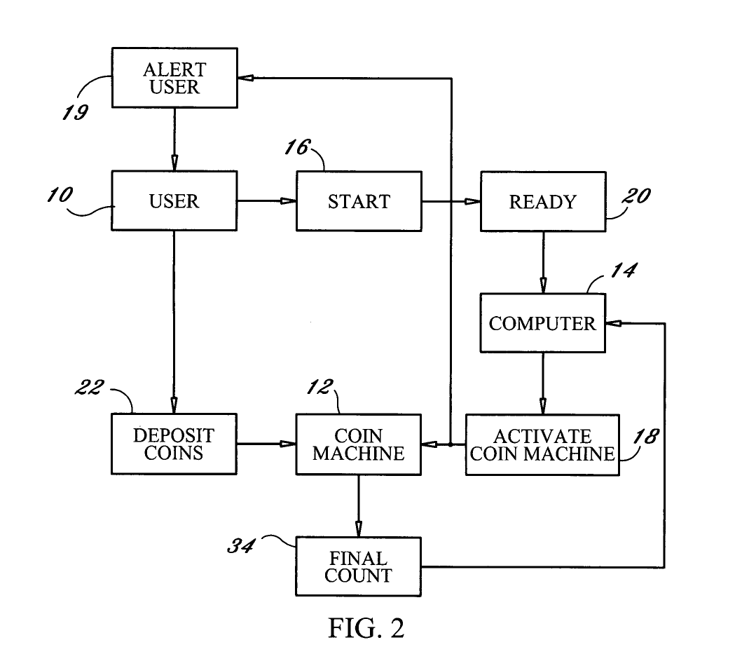

The system and method for controlling a coin redemption machine which is illustrated in FIGS. 1 and 2 is one which employs a coin redemption machine which does not have a data processing computer or printer in it, but simply includes mechanisms for determining the denomination of the coins and for providing a count of the denominations. The coin redemption machine 12 which is shown in FIGS. 1 and 2 is operated as a slave or peripheral device only to a computer, such as the personal computer 14 illustrated in FIGS. 1 and 2.

The computer 14 controls the activation and deactivation and stopping of the coin redemption machine 12, and maintains a constant “command and response” communications link through a cable or wireless communications link to the coin redemption machine to monitor the status of the coin redemption machine 12 and to send specific sequential instructions from the computer 14 to the coin. redemption machine 12 in accordance with a program residing in the computer 14.

While the discussion above refers to the computer 14 as a personal computer, it should be noted that the computer 14 may be a point-of-sale computer located at the cash register location of a retail store, or a point-of-sale kiosk already in place in a store or other establishment. The computer 14 also could be a computer used in conjunction with a banking teller representative, a banking transaction ATM, or teller system host computer to link the transaction which is being effected by use of the coin redemption machine to a consumer's bank account or other designated account.

Essentially, the coin redemption machine 12 of FIGS. 1 and 2 is operated as an adjunct or peripheral device to the point-of-sale system of a retail establishment, or teller system or ATM system for a bank. The transaction which is effected is controlled by the computer 14, and not by the user depositing coins into the coin redemption machine. The transaction operates with the coin redemption machine 12 operating essentially as a “slave” to the computer 14 and, the system functions as a “command and response” system via serial communication between the computer 14 and the coin redemption machine 12.

As shown in FIG. 1, whenever an end user 10, such as a customer of the store or bank, or user of the ATM, wishes to deposit and receive credit for the coins, the customer either presses a start button 16 located on the PC, or touches a command on a kiosk screen, or completes a command at a point-of-sale location, activates the program which allows the computer 14 to control the operation of the coin redemption machine 12. Whichever way this occurs, the “command and response” program in the computer 14 then commences to supply the first command to activate the coin redemption machine 12 via the “activate” command at 18, shown in FIG. 1. This command activates the coin redemption machine 12. After this has been accomplished, a response is sent to the computer 14 from the coin machine 12 that it is “ready” via 20, as shown in FIG. 1. This “ready” status of the coin redemption machine also may be effected by means of a light or other signal on the coin redemption machine itself, or may be effected through a display on the computer 14 to indicate to the end user 10 that the coin redemption machine 12 is ready to receive coins deposited into its hopper or receptacle.

At this time, the end user 10 deposits coins at 22 (FIG. 1) into the hopper or coin receiving receptacle for counting and redemption by the coin redemption machine 12. The computer 14 supplies a “start” command 24 to the coin redemption machine, which responds that it is “okay” at 26 back to the computer 14. The computer then commands, at 28, the coin redemption machine to read the denominations; and the coin redemption machine reports the denominations back to the computer at 30. Once the counting of the different coins has been completed, the computer sends a signal to the coin redemption machine at 32 to read the final count. In response to this signal, the machine 12 then reports back to the computer the final count at 34. Once the final count is reported, the computer 14 sends a signal to the coin redemption machine at 36 to turn off the machine 12.

The count of the different denominations and the computation as to the value of those denominations, along with any deduction of fees to be collected by the owner and controller of the system for the use of the coin redemption machine 12 is calculated by the computer 14. When the computer 14 is the point-of-sale computer at a retail establishment, the net calculated redemption amount may be used directly as a payment or deduction from the tally of other items which are being purchased by the end user 10 who deposited the coins into the coin redemption machine 12 at the time of the overall transaction being effected at the point-of-sale location.

When the computer 14 is associated with an ATM or a teller platform system for example, the net calculated redemption amount of the coins (less any service fee) may be directly credited to the end user's bank account(s) without requiring the printing and handling of a paper receipt or some type of electronic coupon for subsequent redemption. By operating the coin redemption machine 12 as a slave peripheral device, the machine 12 may be simplified, since it does not require its own separate printer or computer for calculating the value of the various coins deposited into it, along with the corresponding service fee. The coin machine 12 simply needs to include the apparatus which is normally used for counting, and as an option, sorting coins of different denominations. All of the calculating and/or printing functions are handled by means of the computer 14, which already includes the capability of performing such functions. The result is a coin redemption machine 12 which is more simple to operate than a machine operated as a stand alone device.

FIG. 2 is a-schematic diagram/flow chart illustrating the system and method of FIG. 1 in a different format from the one used in FIG. 1. In FIG. 2, a user 10 initiates the operation of the system by means of a start button or start switch, which is shown as “start 16” to signal a computer 14 to activate a coin machine program. The computer 14 then activates a coin redemption machine 18. The coin redemption machine 12 is activated and supplies a signal through the computer at 20 that it is “ready”. The coin redemption machine 12 also may separately supply a signal at 19 to alert the user 10 that the coin redemption machine is ready for operation. The signal at 19 may be a simple “ready” lamp which is turned on when the machine 12 is turned on, or it may be any other appropriate signal determined by the parameters of the particular system involved. For example, in the case of an ATM, the signal may appear on the screen of the ATM machine.

Once the user 10 has been alerted that the coin redemption machine 12 is ready, coins are deposited at 22 into the coin redemption machine in a conventional manner. The coin redemption machine then proceeds with processing of the coins to provide a final count at 34 back to the computer 14 in a manner similar to that which has been described previously in conjunction with FIG. 1.

The foregoing description of an embodiment of the invention is to be considered as illustrative and not as limiting. Various changes and modifications will occur to those skilled in the art for performing substantially the same function, in substantially the same way, to achieve substantially the same result without departing from the true scope of the invention as defined in the appended claims.

What is claimed is:

1. A method for operating a coin redemption machine as a peripheral device to a separate computer including: linking the coin redemption machine and the computer for reciprocal communication activating the coin redemption machine for operation from the computer; depositing coins into the coin redemption machine; reporting the final count of deposited coins from the coin redemption machine to the computer for utilization thereby.

2. A method according to Claim 1 further including deactivating the coin redemption machine by the computer following reporting the final count of deposited coins to the computer.

3. A method according to claim 1 further including requesting a readout of the denominations of coins deposited from the computer to the coin redemption machine; and reporting the denominations of the coins deposited from the coin redemption machine to the computer.

3. A method according to claim 1 further including requesting a readout of the denominations of coins deposited from the computer to the coin redemption machine; and reporting the denominations of the coins deposited from the coin redemption machine to the computer.

5. A coin machine control system including in combination: a coin redemption machine; a computer separate from the coin redemption machine; a communications link between the computer and the coin redemption machine; means in the computer for supplying commands to the coin redemption machine over the communications link; and means in the coin redemption machine for providing responses to commands from the computer over the communications link to the computer.

6. A coin machine control system according to claim 5 wherein the means for supplying commands to the coin redemption machine supplies commands for activating and deactivating the coin redemption machine.

7. A coin machine control system according to claim 6 wherein the means in the computer for supplying commands supplies commands in a predetermined sequence alternating with responses to the computer from the means in the coin redemption machine.

8. A coin machine control system according to claim 7 wherein. the communications link between the computer and the coin redemption machine is a cable.

9. A coin machine control system according to claim 5 wherein the means in the computer for supplying commands supplies commands in a predetermined sequence alternating with responses to the computer from the means in the coin redemption machine.

10. A coin machine control system according to claim 9 wherein the communications link between the computer and the coin redemption machine is a cable.

11. A coin machine control system according to claim 5 wherein the communications link between the computer and the coin redemption machine is a cable.
